(19) United States
(12) Patent Application Publication
(10) Pub. No.: US 2022/0143891 A1
(43) Pub. Date: May 12, 2022

(54) Lamella Block with Lamella Openings

(71) Applicant: KRAUSSMAFFEI TECHNOLOGIES GMBH, München (DE)

(72) Inventors: Michael Esswein, Neufahrn (DE); Walter Breuning, Bergkirchen Bayern (DE)

(21) Appl. No.: 17/433,847

(22) PCT Filed: Feb. 13, 2020
(86) PCT No.: PCT/EP2020/053696

§ 371 Date: Aug. 25, 2021

(30) Foreign Application Priority Data
Mar. 21, 2019 (DE) 102019002027.8

(51) Int. Cl. B29C 48/90; B33Y 50/02; B33Y 80/00

(52) U.S. Cl. CPC B29C 48/907; B29C 48/904; B33Y 30/00; B33Y 50/02; B33Y 80/00; B29C 48/903

(57) ABSTRACT

A lamella block for a calibration device for the calibration of an extruded profile, wherein the lamella block includes a lamella structure having a plurality of lamellae, which are spaced apart from one another by grooves and arranged in the longitudinal direction of the lamella block. At least some of the lamellae are provided with at least one lamella opening with a predefined variable geometry. The application also relates to a method for producing said lamella. block, as well as a calibration device comprising a plurality of said lamella blocks. The application further relates to a system for additively manufacturing said lamella block, a corresponding computer program and corresponding data set.

The invention relates to a lamella block for a calibrating device for calibrating an extruded profile. The invention further relates to a method for manufacturing such a lamella block, a system for additively fabricating such a lamella block, and a corresponding computer program and dataset.

Calibrating devices are used for calibrating extruded endless profiles, for example such as pipe profiles. During the manufacture of such profiles, a polymer melt desired for manufacturing the profile is first generated in an extruder. The generated polymer melt is then pressed through an outlet nozzle of the extruder, which prescribes the shape of the profile. The profile exiting the outlet nozzle of the extruder then runs through a calibrating device, which copies the still heated profile in a dimensionally accurate manner.

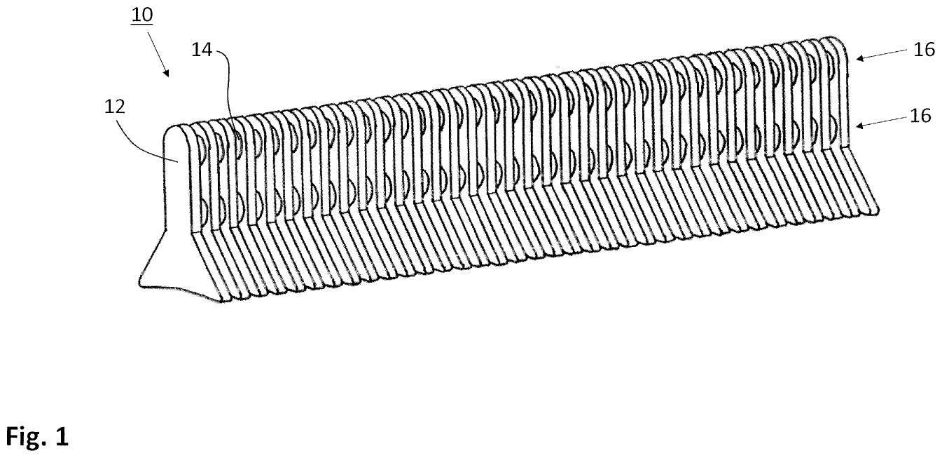

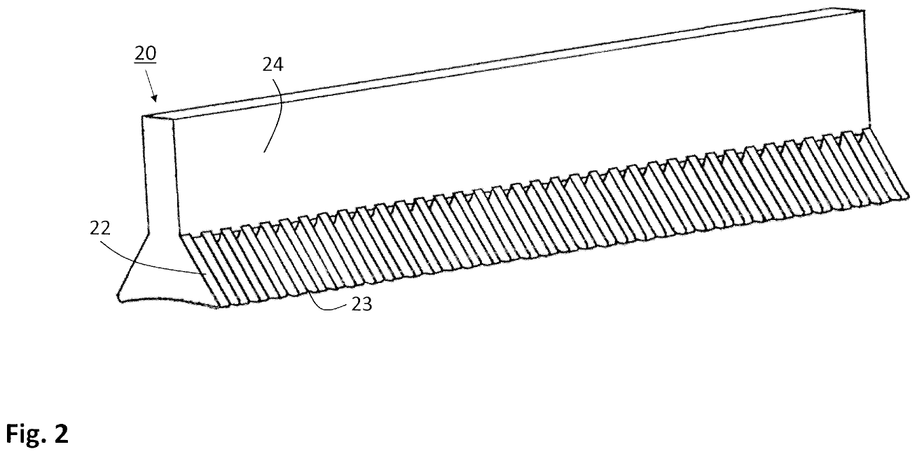

Such a calibrating device for dimensioning extruded profiles is known from DE 198 43 340 C2. Taught therein is a variably adjustable calibrating device, which is designed to calibrate extruded plastic pipes with a varying pipe diameter. The calibrating device comprises a housing and a plurality of lamella blocks circularly arranged in the housing, the lamellae of which can intermesh. The intermeshing lamellae form a calibrating basket with a circular calibrating opening, through which the pipes to be calibrated are guided (see in particular FIGS. 1 and 2 of DE 198 43 340 C2). Each lamella block is further coupled with an activating device, which is provided for individually radially displacing the respective lamella block. In this way, the active cross section of the circular calibrating opening formed by the plurality of lamella blocks can be correspondingly adjusted as needed.

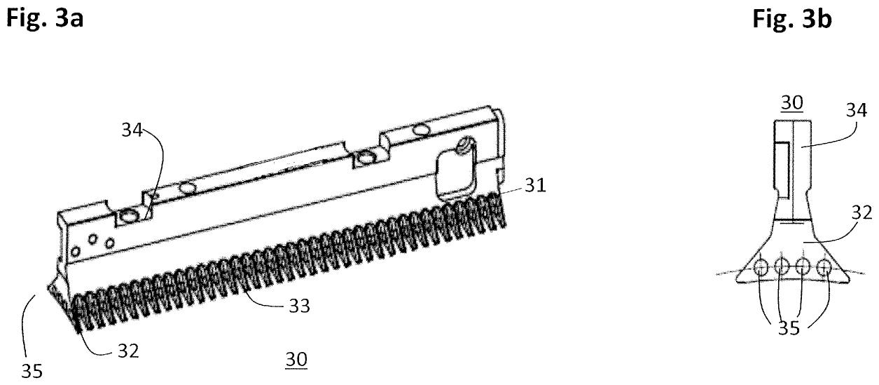

The lamella blocks described in DE 198 43 340 C2 each consist of a plurality of lamellae, which are threaded onto two spaced apart carrier rods. Spacer sleeves are used to maintain a desired distance between neighboring lamellae (see also FIG. 3 of DE 198 43 340 C2). The distances between neighboring lamellae are also referred to as grooves. An example for a threaded lamella block is further shown on FIG. 1. The lamella block 10 shown on FIG. 1 comprises a plurality of lamellae 12 and spacer sleeves 14, which are alternatingly threaded along two carrier rods 16. Such threaded lamella blocks are complicated to manufacture, and thus cost-intensive.

Also known apart from the threaded lamella blocks described above are lamella blocks with closed carrier structures (or back structures). FIG. 2 shows an example of such a lamella block. The lamella block 20 comprises a plurality of lamellae 22, which are carried by a carrier structure 24. The lamellae 22 are arranged along the carrier structure, separated from each other by grooves 23. The block-shaped carrier structure 24 is here realized in the form of a massive body (e.g., a rod-shaped body). The carrier structure 24 is further integrally designed with the lamellae 22. Additional examples of lamella blocks with a closed carrier structure are known from WO 2004/103684 A1. One advantage to lamella blocks with a closed carrier structure 24 lies in the fact that they are relatively easy and cost-effective to manufacture. For example, the integrally designed lamella block 20 depicted on FIG. 2 can be manufactured out of a material block via suitable machining operations (such as milling, cutting to size). However, it is also conceivable to use a casting process to manufacture the lamella block 20.

Because of their massive configuration, the lamellae of the lamella blocks shown on FIGS. 1 and 2 have moderate cooling properties. Effectively cooling the profile to be calibrated with the lamella design described above is technically unfeasible, which in turn is reflected in the quality of the profile surface. In order to improve the cooling properties, it was therefore proposed that the lamellae of the lamella blocks be provided with one or more circular holes. Cooling water can flow through the circular holes (e.g., when the lamellae are submerged in the cooling water sump of the calibrating basket), so that the lamellae can additionally be cooled from inside. Such a lamella design is shown on FIGS. 3a and 3b.

FIG. 3a shows a 3D view of a lamella block 30, which has a carrier structure 34 as well as a lamella structure 31 arranged on the carrier structure 34. The lamella structure 31 comprises a plurality of lamella, which are spaced apart from each other by grooves 33 and each have four circular holes 35. The lamella holes 35 are better illustrated in the side view of the lamella block 30. The holes 35 are uniformly distributed over each lamella 32, and have the same circular hole cross section. In addition, the holes 35 are arranged at the same lamella positions in the sequential lamellae 32. As a consequence, all lamellae 32 have the same borehole geometry.

The arrangement of lamella holes makes it possible to improve the cooling function for the lamellae. However, it has been found that the cooling requirement placed on the lamellae within a lamella block can vary greatly. As a consequence, the approach of providing the lamellae with uniform boreholes described in conjunction with FIGS. 3a and 3b also runs up against its limits, since while the provided boreholes might be adequate for some lamellae, this may not be the case for other lamellae with a high cooling requirement. It has further been shown that the deep hole drilling processes used in prior art for generating boreholes in sequential lamellae is complicated and cost-intensive. Laser cutting can be used in place of deep hole drilling in threaded lamella blocks. However, the overall construction of the threaded lamella block is distinctly more complex and cost-intensive in terms of production and assembly, as described above in conjunction with FIG. 1.

Therefore, the object of the present invention is to provide lamella blocks for a calibrating device that eliminate the problems enumerated in conjunction with prior art. The object of the present invention is further to provide lamella blocks that are cost-effective to manufacture and have an optimized cooling behavior.

The object mentioned above and other objects are achieved by providing a lamella block for a calibrating device to calibrate an extruded plastic profile. The lamella block comprises a lamella structure, which has a plurality of lamellae that are spaced apart from each other by grooves and arranged in the longitudinal direction of the lamella block, wherein at least several of the lamellae are provided with at least one lamella opening with a prescribed, variable geometry.

The at least one lamella opening arranged in a lamella can penetrate through the lamella (essentially) in the longitudinal direction of the lamella block or even transverse to the longitudinal direction of the lamella block (so-called radial lamella penetration). Also conceivable is an opening that runs inclinedly relative to the longitudinal direction (for example, a diagonal opening progression).

The geometry of the lamella opening can essentially refer to the cross sectional geometry (cross sectional shape and/or cross sectional expansion) of the opening. Cross sectional shape (cross sectional expansion) can refer to the shape (expansion) of the opening in a plane perpendicular to the direction in which the opening runs. If the opening is designed to run (essentially) parallel to the longitudinal direction of the lamella block, cross sectional shape (cross sectional expansion) can refer to the shape of the opening in a plane perpendicular to the longitudinal direction of the lamella block. Apart from the cross sectional shape, the geometry of the opening can also depend on the progression of the opening.

The number of lamella openings can be individually adjusted for each lamella. Alternatively or additionally to the number of lamella openings, the geometry of the lamella openings can also be individually adjusted for each lamella. In particular, the number and/or geometry of the lamella openings (in particular the cross sectional shape and/or cross sectional expansion of the openings) can be adjusted to the expected cooling requirement to be placed on the respective lamella of the lamella structure. For example, if the expected cooling requirement of a lamella is slight, only one or even no lamella opening can be provided for the corresponding lamella. If the lamella has a lamella opening, the opening can have a cross sectional surface that is small by comparison to the cross sectional surface of the lamella. The lamella opening thus only takes up a small portion of the lamella cross sectional surface. By contrast, lamellae with a comparatively high cooling requirement can have several lamella openings. The several lamella openings can together comprise an overall cross sectional surface that assumes a larger portion of the lamella cross sectional surface. The overall cross sectional surface of the openings can here take up more than 50% of the lamella cross sectional surface.

The geometry (cross sectional shape and/or cross sectional expansion) of lamella openings of sequential lamellae can vary. For example, lamellae along the lamella block can be provided with lamella openings, which have cross sectional shapes and/or cross sectional expansions that differ from each other. The selection of opening geometry for each lamella can be adjusted accordingly to the expected cooling requirement of each lamella. Alternatively thereto, it is also conceivable for the lamella openings of sequential lamellae to have the same geometry. In such a case, the openings of sequential lamellae are identical in design.

If several (i.e., at least two) lamella openings are arranged in a lamella, the lamella openings within the lamella can have the same geometry or geometries that differ from each other. In particular, the cross sectional shapes and/or cross sectional expansions of the several lamella openings within the lamella can be configured differently from each other.

In addition, the lamella openings of sequential lamellae can be arranged offset relative to each other. The lamella openings of sequential lamellae can be arranged offset relative to each other transverse to the longitudinal direction of the lamella block. As a consequence, the lamellae can be arranged at varying lamella positions. The openings of sequential lamellae need not repeat at the same lamella positions. Rather, the arrangement of lamella openings can vary from lamella to lamella.

The cross sectional geometry of each lamella opening can be adjusted to the lamella geometry. In particular, the cross sectional shape of each lamella opening can be adjusted to the cross sectional shape of the corresponding lamella. The cross sectional shape of each lamella opening can here be shaped like a triangle, rectangle, polygon, circle, semicircle, ellipse or have some other shape. The shape and arrangement of each lamella opening within a lamella can be selected in such a way that each lamella opening contributes to an improved cooling function, without in so doing mechanically weakening the lamella structure in any significant way.

The lamella block can further have a carrier structure in which the lamellae of the lamella structure are fastened. The carrier structure can be designed in the form of one or several carrier rods or one massive carrier structure, as described in conjunction with FIGS. 1 and 2 at the outset.

The carrier structure can be integrally designed with the lamellae or the lamella structure. As an alternative, the lamella structure or the lamellae along with the carrier structure can each be separately fabricated. The lamella structure or lamellae can then be correspondingly connected with the carrier structure.

The carrier structure and the lamellae can be fabricated out of the same material or out of different materials. In one variant, the material used to fabricate the carrier structure and/or the lamellae can be made out of a metal material. However, the use of a polymer material (with additives) is also conceivable.

The lamella block with individually adjusted lamella openings described above is preferably manufactured by means of 3D printing. Applying a 3D printing technique makes it possible to cost-effectively and quickly manufacture lamella blocks, wherein any opening geometry desired can be realized.

Another aspect of the invention provides a calibrating device for calibrating extruded plastic profiles, wherein the calibrating device has a plurality of the lamella blocks according to the invention, which are arranged relative to each other so as to form a calibrating opening. The lamella blocks can here be arranged in such a way as to form a circular calibrating opening.

The calibrating device can further comprise a plurality of activating devices, wherein each activating device is coupled with a respective lamella block, so as to individually activate each lamella block. The activating device can be used to individually activate each lamella block radially to the calibrating opening. As a result, the active cross section of the calibrating opening can be adjusted to the cross section (diameter) of the profile to be calibrated as needed.

The calibrating device can further have a housing that is provided to accommodate and store the activating device and the lamella blocks coupled with the activating device.

Another aspect of the invention provides a method for manufacturing a lamella block as described above. The method for manufacturing a lamella block involves at least the step of manufacturing the lamella block by means of 3D printing or additive manufacturing processes. The manufacture of the lamella block in a 3D printing process or additive manufacturing processes can here comprise the layer by layer laser sintering or laser melting of material layers, wherein the material layers are applied one after the other (sequentially) according to the shape of the lamella block to be generated.

The method can further involve the step of calculating a lamella block geometry (CAD data). In addition, the method can involve the step of converting the 3D geometric data into corresponding control commands for 3D printing or additive manufacture.

In particular, the step of calculating a 3D lamella block geometry can involve the step of calculating lamella openings, wherein the geometry and arrangement of the lamella openings are individually calculated for each lamella of the lamella structure. This makes it possible to generate a lamella block with lamella openings individually adjusted for each lamella.

Another aspect provides a method for manufacturing a lamella block, which involves the following steps: Generating a dataset, which images the lamella block as described above, and storing the dataset on a storage device or a server. The method can further involve: Inputting the dataset into a processing device or a computer, which actuates an additive manufacturing device so that the latter fabricates the lamella block imaged in the dataset.

Another aspect provides a system for additively manufacturing a lamella block, with a dataset generating device for generating a dataset that images the lamella block described as above, a storage device for storing the dataset and a processing device for receiving the dataset and for actuating an additive manufacturing device in such a way that the latter fabricates the lamella block imaged in the dataset. The storage device can be a USB stick, a CD ROM, a DVD, a memory card or a hard disk. The processing device can be a computer, a server or a processor.

Another aspect provides a computer program or computer program product, comprising datasets, which while the datasets are being read in by a processing device or a computer, prompts the latter to actuate an additive manufacturing device in such a way that the additive manufacturing device fabricates the lamella block as described above.

Another aspect provides a computer-readable data carrier, which stores the computer program described above. The computer-readable data carrier can be a USB stick, a CD-ROM, a DVD, a memory card or a hard disk.

Another aspect provides a dataset, which images the lamella block as described above. The dataset can be stored on a computer-readable data carrier.

Additional advantages, details and aspects of the present invention are discussed based on the drawings below. Shown on:

FIG. 1 is a lamella block for a calibrating device according to prior art;

FIG. 2 is another lamella block for a calibrating device according to prior art;

FIGS. 3a/3b are views of another lamella block according to prior art;

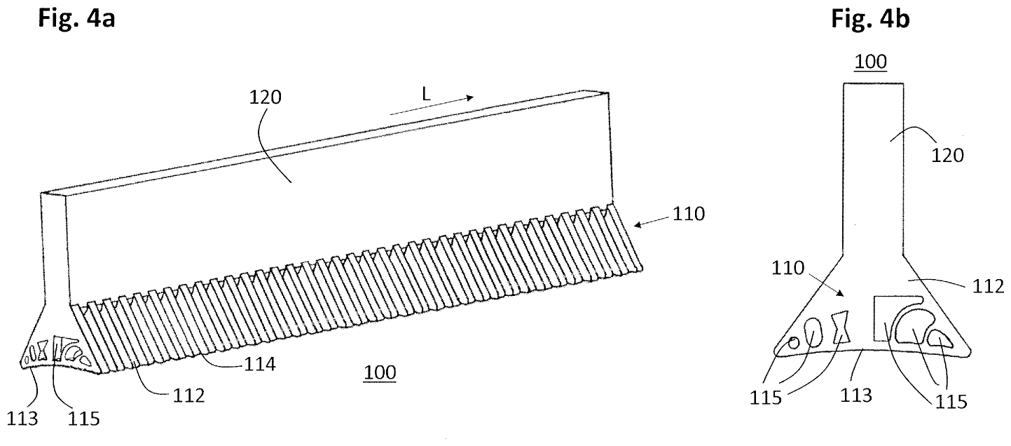

FIG. 4a/4b are views of a lamella block according to the invention;

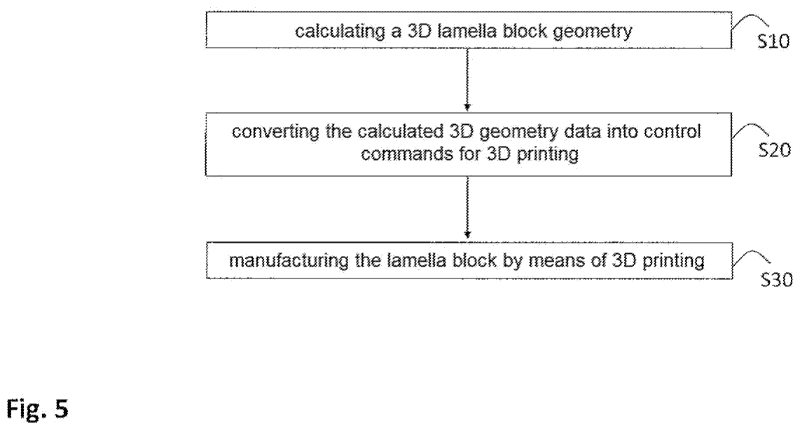

FIG. 5 is a block diagram of a method for manufacturing the lamella block according to the invention on FIGS. 4a and 4b; and

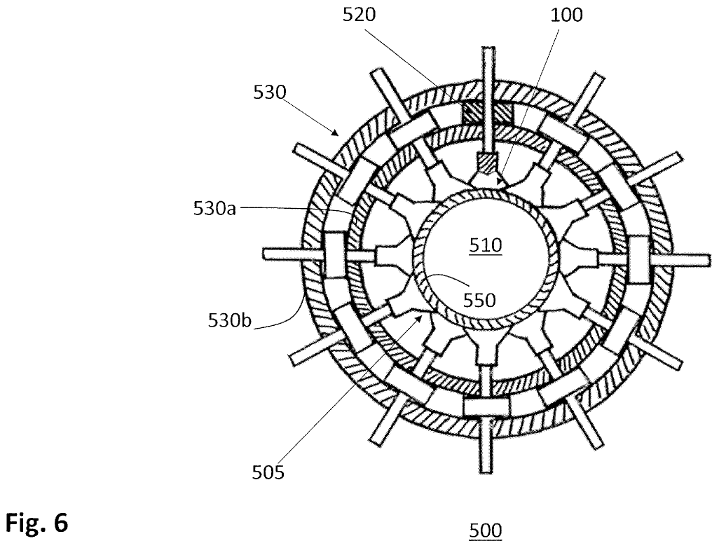

FIG. 6 is a calibrating device according to the present invention.

FIGS. 1, 2, 3a and 3b were already discussed at the outset in conjunction with prior art. Let reference be made to the description there.

In conjunction with FIGS. 4a and 4b, an example for a lamella block 100 according to the invention for a calibrating device will now be described further. FIG. 4a shows a three-dimensional view of the lamella block 100. FIG. 4b shows a front view of the lamella block 100 corresponding thereto.

The lamella block 100 comprises a carrier structure 120 as well as a lamella structure 110, which comprises a plurality of lamellae 112. The carrier structure 120 acts as a carrier for the lamella structure 110.

The lamella block 100 can further have a coupling device (not shown on FIGS. 4a and 4b). The coupling device is provided for coupling with an activating device of a calibrating device. The activating device is likewise not visible on FIGS. 4a and 4b. According to one implementation, the coupling device can have two or more threaded holes spaced apart from each other. The threaded holes can be integrated into the carrier structure 120.

The carrier structure 120 is designed as a massive body. The carrier structure 120 has a rectangular profile in the cross section perpendicular to the longitudinal direction. Other profiles deviating from a rectangular cross sectional profile are likewise conceivable. Instead of the massive carrier body shown on FIG. 4a, the lamella block 100 can also have several carrier rods, to which the lamellae 112 are fastened.

The lamella structure 110 of the lamella block 100 according to the invention will now be described in more detail. The lamella structure 110 comprises a plurality of lamellae 112, which are spaced apart from each other in the longitudinal direction L of the lamella block 100 (see FIG. 4a). Neighboring lamellae 112 are separated from each other by corresponding grooves 114. Each lamella 112 has a triangular cross sectional profile relative to the longitudinal direction L. Each lamella 112 further has a lamella surface 113 that faces away from the carrier structure 120, and is slightly curved in design. The lamella surface 113 faces the profile to be calibrated. It forms the contact surface with the profile to be calibrated. Depending on the application, the lamella block 100 can also have a different lamella shape that can deviate from the triangular cross sectional profile described here. The lamella surface 113 facing the profile to be calibrated can likewise be flat or have some other kind of curvature.

As further denoted on FIGS. 4a and 4b, at least several of the lamellae 110 arranged along the lamella block 100 have openings 115. The lamella 112 on the front side of the lamella block 100 shown on FIGS. 4a and 4b exemplarily has six lamella openings 115, which each penetrate the lamella 112 in a longitudinal direction L of the lamella block 100 (essentially along a straight line). The essential difference between the individual lamella openings 115 lies in their geometric configuration. As readily discernible from the front side view on FIG. 4b, the six openings 115 differ from each other in terms of their cross sectional shape and cross sectional expansion. The cross sectional shape and cross sectional expansion of the openings 115 here varies as a function of their arrangement within the lamella 112. For example, the openings arranged in the lamella center have a significantly larger cross sectional expansion than those openings 115 arranged at the tapered outer areas of the lamella 112. Much the same otherwise also holds true for the cross sectional shape of the individual lamella openings 115, which are correspondingly adjusted to the triangular cross sectional shape of the lamella 112. Individually adjusting the (cross sectional) geometry of the openings 115 to the lamella geometry as described here makes it possible to optimize (maximize) the overall opening surface generated by the lamella openings 115, without significantly weakening the mechanical stability of the lamella 112. Optimizing (maximizing) the opening surface makes it possible to distinctly improve (optimize) the cooling function of the lamella 112.

The openings 115 shown on FIGS. 4a and 4b are purely exemplary. It goes without saying that the number of openings 115 per lamella 112 is not limited to six openings 115, but instead can vary depending on the cooling requirement of a lamella 112. Likewise, the cross sectional geometry (in particular the cross sectional shape) of the openings 115 is not limited to the one on FIGS. 4a and 4b. The openings 115 can have cross sectional shapes that are elliptical, semicircular, circular, triangular, rectangular and/or otherwise polygonal. It is critical that the number and/or cross sectional geometry of the openings be correspondingly adjusted to the cooling requirement of the respective lamella.

As further evident from FIGS. 4a and 4b, the carrier structure 120 is integrally designed together with the lamella structure 110. A generative or additive manufacturing process can preferably be used to manufacture the lamella block 100 with variable lamella openings 115 shown on FIGS. 4a and 4b. This type of manufacturing process is shown on FIG. 5, and will be described in more detail below.

Use is thus made of a 3D printing process. In a first step S10, a 3D lamella block geometry (CAD data) is here calculated. In particular, the 3D lamella block geometry (or the CAD data describing the 3D lamella block geometry) comprise the individually adjusted lamella openings provided for each lamella. The number, geometry and arrangement of lamella openings can here be individually calculated for each lamella taking prescribed model parameters into account (for example, the geometry of the lamella, material of the lamella, thermal and mechanical properties of the lamella).

In a subsequent second step S20, the calculated 3D geometry data are converted into control commands for operating a 3D printer. The 3D printer can be configured for executing a 3D printing process (e.g., a laser sintering process or laser melting process).

Based on the generated control commands, the lamella block 100 is then built up layer by layer with the 3D printer (step S30). A metal material or a polymer material can be used as the material for 3D printing.

The 3D printing process described here for manufacturing the lamella blocks according to the invention is advantageous, since any opening shapes required can be realized in the lamellae. The opening shapes need not remain confined to uniform, circular holes, but can instead be variably designed depending on the cooling requirement (and lamella geometry). The arrangement and geometry of the openings can be optimized for each lamella, with the objective of exposing the lamella to an optimal cooling, for example while it is being submerged in the cooling water sump of the calibrating basket.

Described in conjunction with FIG. 6 is a calibrating device 500 for calibrating an extruded plastic profile 550. FIG. 6 shows a sectional view of the calibrating device 500. The profile 550 to be calibrated is a pipe profile in the implementation depicted on FIG. 6.

The calibrating device 500 comprises a plurality of the lamella blocks 100 according to the invention described above, which are arranged in such a way relative to each other in the peripheral direction of the calibrating device 500 as to form a calibration basket 505 with a desired calibrating opening 510. As further schematically denoted on FIG. 5, the neighboring lamella blocks 100 can be intermeshing in design. To this end, the lamellae 112 and grooves 114 of neighboring lamella blocks 100 are tailored to each other in terms of their arrangement and dimensions (in particular in terms of the groove width and lamella width) in such a way that the lamellae 112 of neighboring lamella blocks 100 can mesh into each other in a comb-like manner.

The calibrating device 500 further comprises a plurality of activating devices 520 (for example, linear actuators), wherein one respective activating device 520 is coupled with one lamella block 100. The activating devices 520 are provided to displace the respective lamella blocks 100 in a radial direction (i.e., perpendicular to the feed direction of the profile to be calibrated). This makes it possible to correspondingly adjust the active cross section of the calibrating opening to the profile to be calibrated.

The calibrating device 500 further comprises a housing 530 for receiving the activating devices 520 and the lamella blocks 100. The housing 530 can be cylindrical in design. It can have an inner housing cylinder 530a and an outer housing cylinder 530b, wherein components of the activating device 520 can be arranged in the gap between the inner housing cylinder 530a and the outer housing cylinder 530b, similarly to the calibrating device described in DE 198 43 340 C2.

What is claimed is:

1-19. (canceled)

20. A lamella block (100) for a calibrating device (500) for calibrating an extruded profile (550), wherein the lamella block (100) comprises a lamella structure (110), which has a plurality of lamellae (112) that are spaced apart from each other by grooves (114) and arranged in the longitudinal direction of the lamella block (100), characterized in that at least several of the lamellae (112) are provided with at least one lamella opening (115) with a prescribed, variable geometry, wherein the geometry of lamella openings (115) varies within a lamella (112).

21. The lamella block (110) according to claim 20, wherein the geometry of the lamella openings (115) of sequential lamellae (112) varies.

22. The lamella block (100) according to claim 20, wherein the lamella openings (115) of sequential lamellae (112) are arranged offset relative to each other.

23. The lamella block (110) according to claim 20, wherein the lamella block (100) further has a carrier structure (120) on which the lamellae (112) of the lamella structure (110) are fastened.

24. The lamella block (100) according to claim 20, wherein the lamella block (100) is integrally designed.

25. The lamella block (100) according to claim 20, wherein the lamella block (100) is manufactured by means of 3D printing or by means of an additive manufacturing process.

26. A calibrating device (500) for calibrating extruded profiles (510), comprising a plurality of lamella blocks (100) according to claim 20, wherein the lamella blocks (100) are arranged relative to each other to form a calibrating opening (510).

27. The calibrating device according to claim 26, wherein the calibrating device (500) comprises a plurality of activating devices (520), wherein each activating device (520) is coupled with a respective lamella block (100), so as to individually activate each lamella block (100).

28. A method for manufacturing a lamella block (100) according to claim 20, involving the step of manufacturing the lamella block (100) by means of 3D printing or additive manufacturing.

29. The method according to claim 28, further comprising the step of calculating a 3D lamella block geometry, and converting the calculated 3D geometry data into corresponding control commands for 3D printing or additive manufacturing.

30. The method according to claim 29, wherein the step of calculating the 3D lamella block geometry comprises: Calculating lamella openings (115), wherein the number of lamella openings (115) and/or the geometry of the lamella openings (115) is calculated individually for each lamella (112).

31. A method for manufacturing a lamella block (100), which comprising the following steps:
generating a dataset, which images the lamella block (100) according to claim 20;
storing the dataset on a storage device or a server; and
inputting the dataset into a processing device or a computer, which actuates an additive manufacturing device in such a way that the latter fabricates the lamella block (100) imaged in the dataset.

32. A computer program, comprising datasets, which while the datasets are being read in by a processing device or a computer, prompts the latter to actuate an additive manufacturing device in such a way that the additive manufacturing device fabricates a lamella block (100) with the features according to claim 20.

33. A computer-readable data carrier, which stores the computer program according to claim 32.
